(19) United States
(12) Patent Application Publication
(10) Pub. No.: US 2006/0248201 A1
(43) Pub. Date: Nov. 2, 2006

(54) Communication system

(75) Inventors: Michael Eckert, Braunschweig (DE); Hyung-Nam Choi, Hamburg (DE); Michael Benkert, Burgdorf/Hohenassel (DE); Maik Bienas, Hannover (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Munich (DE)

(21) Appl. No.: 11/368,275

(22) Filed: Mar. 3, 2006

(30) Foreign Application Priority Data
Mar. 3, 2005 (DE) 102005010081.3-31

(51) Int. Cl. G06F 15/16

(52) U.S. Cl. 709/227; 709/231

(57) ABSTRACT

Server of a communication system having a broadcast communication network, a communication service server and a storage device, the server providing a plurality of media streams which can be transmitted in a service area of the broadcast communication network by the broadcast communication network. The server includes a determination device that interrogates parameter values from a storage device for each client situated in the service area, and receives data which are transmitted by the broadcast communication network, wherein the parameter values are used to determine which of the media streams are intended to be communicated to the respective client, and determines based on the parameter values which of the media streams are intended to be transmitted by the broadcast communication network in the service area. The server also includes a controller that controls the broadcast communication network such that the network transmits the media streams which are intended to be transmitted.

### CROSS-REFERENCE TO RELATED APPLICATION

This application claims priority to German Patent Application Ser. No. 10 2005 010 081.3-31, which was filed on Mar. 3, 2005, and is incorporated herein by reference in its entirety.

### FIELD OF THE INVENTION

The invention relates to a communication system, a method for controlling a broadcast communication network, a server unit, a method for operating a server unit, a client unit and a method for operating a client unit.

### BACKGROUND OF THE INVENTION

In the standardization forum OMA (Open Mobile Alliance) there are considerations to combine DVB-H and bidirectional (that is to say with return channel capability) mobile radio communication systems, such as UMTS communication systems for example, with one another. The communication system planned and arising in this case is designated as BCAST within the framework of the OMA.

In this case, one aim is to supply the users (that is to say the mobile radio subscribers) of the communication system with multimedia data resource-efficiently and cost-effectively by means of DVB-H and furthermore to enable the users, by means of a return channel, to intervene interactively in the transmission of the multimedia data and for example to influence the control and the properties of the data transmission.

Possible applications of BCAST are communication services such as online games, dedicated download and also control mechanisms such as, for example, for authentication, authorization and negotiations of keys, and also procedures for charging for the communication services utilized by the users (charging, billing).

One envisaged requirement made of BCAST is to provide communication services in the context of which different media streams having different contents, media formats and codings are provided and, if appropriate, transmitted to a receiver. The media streams are intended to be communicated and received in synchronized fashion. The media streams of such a communication service (that is to say which are provided in the context of the communication service) are the service elements of the communication service; a communication service having the designation “cinema films” may have for example the media streams “video” (video data of a cinema film) “music” (music data of a cinema film), “language 1” to “language N” (speech data of a cinema film), “subtitle 1” to “subtitle N” (subtitle data for a cinema film) and “additional info” (additional information). Since different service elements (media streams) are provided in the context of such a communication service, the communication service is clearly provided with a specific granularity. The network element which provides such a communication service is a so-called content provider or a so-called service provider.

Various methods for communicating the individual media streams which are provided in the context of such a communication service, to put it another way the components of the communication service. Such methods are used inter alia for multimedia applications such as, for example, Microsoft NetMeeting, which is based on ITU-T (International Telecommunication Union—Telecommunication Standardization Bureau) standard H.323, in which the users communicate with one another by means of communication services for the transmission of speech data, video data and general data.

Furthermore, special codecs, so-called layer codecs, are provided for the data transmission in the context of a communication service, in the case of which codecs a main data stream and further data streams are transmitted. The data transmitted in the context of the main data stream enable only a minimum quality of service or a basic quality of service (QOS) of the communication service and, in the context of the further data streams, additional signals or differential signals are communicated which, together with the data communicated in the context of the main data stream, enable a higher quality of service of the communication service.

In the case of a point-to-region transmission, a so-called broadcast, that is to say a broadcasting of data, it is not possible for individual components of a communication service to be transmitted or not to be transmitted depending on the presence of possible receivers of the data and/or depending on the preferences and capabilities, that is to say terminal capabilities of the possible receivers of the data, that is to say whether the possible receivers can (on account of the capabilities of the receiving devices used) or wish to receive a specific service component.

Consequently, in conventional broadcast communication systems, when data provided in the context of a communication service are transmitted, all the components of the communication service are always transmitted.

Within the framework of the OMA, only the requirements made of BCAST and the fundamental architecture of BCAST has been discussed hitherto. Mechanisms and the required signaling between the network elements involved for the realization of BCAST have not yet been presented or discussed within the framework of the OMA.

There is a need in an improved broadcast communication systems with less data transfer via the communication network(s) used.

### SUMMARY OF THE INVENTION

In an exemplary embodiment of the invention, a server unit of a communication system has a broadcast communication network, a communication service server unit and a storage device. The server unit provides, in context of a communication service, a plurality of media streams which can be transmitted in at least one service area of the broadcast communication network by the broadcast communication network. The server unit includes a determination device that interrogates parameter values from a storage device for each client unit which is situated in the service area, and receives data which are transmitted by the broadcast communication network, wherein the parameter values are used to determine which of the media streams are intended to be communicated to the respective client unit; and determines based on the parameter values which of the media streams are intended to be transmitted by the broadcast communication network in the service area. The server unit also includes a controller device that controls the broadcast communication network such that the broadcast communication network transmits the media streams which are intended to be transmitted.

An embodiment of the invention provides a more efficient utilization of broadcast communication networks.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a communication system in accordance with one exemplary embodiment of the invention.

FIG. 2 shows a flow chart in accordance with one exemplary embodiment of the invention.

FIG. 3 shows a flow chart in accordance with one exemplary embodiment of the invention.

### DETAILED DESCRIPTION OF PREFERRED EMBODIMENTS OF THE INVENTION

Digital terrestrial television has recently been introduced in the form of a DVB-T (digital video broadcast—terrestrial).

DVB-T is used to implement the terrestrial broadcasting in particular of TV programs for stationary and portable receivers.

A broadcast communication service that is compatible with DVB-T is DVB-H (digital video broadcast—handheld), which is provided for portable and transportable devices such as, for example, mobile radio telephones and pocket computers (PDAs) provided with a mobile radio interface.

The use of DVB-H makes it possible for the power consumption required for mobile receivers for utilizing the respective video broadcast communication service to be reduced significantly (approximately by 95%) compared with DVB-T. Therefore, DVB-H is suitable particularly for small transportable devices with a corresponding receiver which have a comparatively severely limited power supply. By way of example, the inconveniently frequently required charging of rechargeable batteries which serve as the power supply for the devices can be avoided or the operating time during which energy is supplied by a rechargeable battery can be lengthened.

It is provided that video signals are transmitted at a much lower data rate by means of DVB-H than by means of DVB-T, because principally devices having low-resolution displays (typically 360 by 288 pixels) are intended to be supplied with video data by means of DVB-H and because the video compression method H.264 used in the case of DVB-H is significantly more efficient than the MPEG-2 video coding used in the case of DVB-T.

It is possible, for example, to transmit up to 50 TV programs by means of a terrestrial TV channel with a bandwidth of 8 MHz if the TV programs are coded in accordance with DVB-H. In this way, low transmission costs per TV program can be achieved and communication services with strict cost restrictions can be operated lucratively.

UMTS (Universal Mobile Telecommunications System) communication systems are mobile radio communication systems for universal mobile radio telecommunications that are standardized by the ETSI (European Telecommunication Standard Institute).

Primarily in the field of multimedia technology, a UMTS communication system, that is to say a communication system in accordance with the UMTS standard, enables the provision of more powerful multimedia communication services on account of the significantly higher data transmission rates than are provided for example by a GSM (global system for mobile communication) communication system.

A UMTS communication system has the performance features of the circuit switching of the technology on which the GSM communication systems are based, and also the performance features of the packet switching of the technology on which the GPRS (General Packet Radio Service) is based, and thus fulfils the preconditions for fast data transfer.

Furthermore, the UMTS standard has specifications which provide for the data transport on the basis of the IP (Internet protocol) and thus enable the use of UMTS communication systems for radio-based Internet access. UMTS communication systems furthermore enable visually oriented communication services. By way of example, video telephony services and streaming services for the transmission of audio data and video data, for example video clips, can be utilized by means of UMTS mobile radio subscriber devices.

A UMTS communication system is a cellular mobile radio communication system in which data are transmitted by means of dedicated point-to-point connections in the downlink and in the uplink between mobile (mobile radio) subscriber devices and the radio network of the UMTS communication system, which is referred to as UTRAN (UMTS Terrestrial Radio Access Network).

In the standardization forum OMA (Open Mobile Alliance) there are considerations to combine DVB-H and bidirectional (that is to say with return channel capability) mobile radio communication systems, such as UMTS communication systems for example, with one another. The communication system planned and arising in this case is designated as BCAST within the framework of the OMA.

In this case, one aim is to supply the users (that is to say the mobile radio subscribers) of the communication system with multimedia data resource-efficiently and cost-effectively by means of DVB-H and furthermore to enable the users, by means of a return channel, to intervene interactively in the transmission of the multimedia data and for example to influence the control and the properties of the data transmission.

Possible applications of BCAST are communication services such as online games, dedicated download and also control mechanisms such as, for example, for authentication, authorization and negotiations of keys, and also procedures for charging for the communication services utilized by the users (charging, billing).

One envisaged requirement made of BCAST is to provide communication services in the context of which different media streams having different contents, media formats and codings are provided and, if appropriate, transmitted to a receiver. The media streams are intended to be communicated and received in synchronized fashion. The media streams of such a communication service (that is to say which are provided in the context of the communication service) are the service elements of the communication service; a communication service having the designation “cinema films” may have for example the media streams “video” (video data of a cinema film) “music” (music data of a cinema film), “language 1” to “language N” (speech data of a cinema film), “subtitle 1” to “subtitle N” (subtitle data for a cinema film) and “additional info” (additional information). Since different service elements (media streams) are provided in the context of such a communication service, the communication service is clearly provided with a specific granularity. The network element which provides such a communication service is a so-called content provider or a so-called service provider.

In the case of a point-to-region transmission, a so-called broadcast, that is to say a broadcasting of data, it is not possible for individual components of a communication service to be transmitted or not to be transmitted depending on the presence of possible receivers of the data and/or depending on the preferences and capabilities, that is to say terminal capabilities of the possible receivers of the data, that is to say whether the possible receivers can (on account of the capabilities of the receiving devices used) or wish to receive a specific service component.

Consequently, in conventional broadcast communication systems, when data provided in the context of a communication service are transmitted, all the components of the communication service are always transmitted.

Within the framework of the OMA, only the requirements made of BCAST and the fundamental architecture of BCAST has been discussed hitherto. Mechanisms and the required signaling between the network elements involved for the realization of BCAST have not yet been presented or discussed within the framework of the OMA.

In accordance with one embodiment of the invention, provision is made of a communication system having a broadcast communication network, a communication service server unit, a storage device, a determination device and a controller device, wherein the communication service server unit is set up to provide, in the context of a communication service, data which can be transmitted in at least one service area of the broadcast communication network by means of the broadcast communication network, and wherein parameter values are stored in the storage device for each client unit which is situated in the service area, and is set up to receive data which are transmitted by means of the broadcast communication network, which parameter values can be used to determine which of the data provided are intended to be communicated to the respective client unit. The determination device is set up to determine on the basis of the parameter values which of the data provided are intended to be transmitted by means of the broadcast communication network in the service area. The controller device is set up to control the broadcast communication network in such a way that it transmits the data provided which are intended to be transmitted.

In accordance with another embodiment of the invention, provision is made of a server unit of a communication system, which communication system has a broadcast communication network, a communication service server unit and a storage device, wherein the communication service server unit is set up to provide, in the context of a communication service, data which can be transmitted in at least one service area of the broadcast communication network by means of the broadcast communication network. The server unit has a determination device, which is set up to interrogate parameter values from a storage device for each client unit which is situated in the service area, and is set up to receive data which are transmitted by means of the broadcast communication network, which parameter values can be used to determine which of the data provided are intended to be communicated to the respective client unit; and is set up to determine on the basis of the parameter values which of the data provided are intended to be transmitted by means of the broadcast communication network in the service area. Furthermore, the server unit has a controller device, which is set up to control the broadcast communication network in such a way that it transmits the data provided which are intended to be transmitted.

In accordance with yet another embodiment of the invention, provision is made of a client unit of a communication system, which has a signaling device set up to communicate to a server unit a message with parameter values which can be used to determine which of the data provided by a communication service server unit in the context of a communication service are intended to be communicated to the client unit by means of a broadcast communication network of the communication system.

In accordance with an exemplary embodiment of the invention, provision is made of a method for controlling a broadcast communication network, a method for operating a server unit and a method for operating a client unit in accordance with the above-described communication system, the above-described server unit and the above-described client unit, respectively.

The broadcast communication network in accordance with an embodiment of the invention clearly takes account of whether it is actually necessary (or practical) for specific data to be broadcast by means of the broadcast communication network in the service area. The parameter values specify for example whether potential receivers, that is to say client units, are present in the service area, and which data the users of the client units present wish to receive or can receive on account of the capabilities of the client units, or which data can be processed by means of the client units. According to this information, the determination device determines which of the data provided are actually transmitted by means of the broadcast communication network in the service area.

The storage device may be used for example to manage and store a database which stores, for the communication service (and, if appropriate, for further communication services), whether and how many client units that are set up to receive data sent by means of the broadcast communication network, and that are registered for the communication service, are situated in the service area (broadcast service area) and which components of the communication service—which are also referred to as media streams—are intended to be communicated to these client units (according to preferences of the users of the client units). Furthermore, the database can store, for each client unit, an indication of the capabilities of the respective client unit (or of the respective communication terminal by means of which the respective client unit is realized). In this way it is possible to check whether specific media streams can be received and processed at all by one of the client units present (in the service area), and it is thus possible to decide whether the respective media stream is communicated by means of the broadcast communication network.

A user of a client unit signals to the communication system for example his preferences, that is to say the indication of what components of a communication service he would like to receive, and the preferences are correspondingly stored by means of the storage device.

This signaling (and, if appropriate, an analogous signaling of the capabilities of the user's client unit) is carried out for example when the user decides on the use of the communication service or of a new component of the communication service and correspondingly registers (subscription) for this or if the user together with his client unit moves (roaming) into the service area of the broadcast communication network (possibly from another service area of the broadcast communication network). The signaling is carried out for example by means of a mobile radio communication network which is provided with back channel capability (bidirectional), for example a UMTS (Universal Mobile Telecommunication System) mobile radio communication network (in the uplink direction).

One advantage of an exemplary embodiment of the invention is that only data are communicated which are also actually intended to be communicated to client units situated in the service area, for example wish to be received by the corresponding users and can be received and processed by the client units. Radio resources of the broadcast communication network can be saved in this way. Furthermore, the client units, in the context of the communication service, receive fewer data which are not intended to be transmitted to them. In accordance with one embodiment of the invention, the client units have to filter out fewer data from the received data. In this way, a lower signal processing outlay is required, as a result of which a lower current consumption is required in the client units (or the corresponding terminals) and the requirements with regard to the performance and the memory demand made of the client units can be reduced.

As a result of saving radio resources of the broadcast communication network, more radio resources are available for further communication services or for signaling tasks.

In accordance with an exemplary embodiment of the invention, it has clearly been recognized that it is advantageous to take account of whether users of the communication service, that is to say receivers of the data to be transmitted, are present in the region in which the data are broadcast, and whether the different components wish or can be received by the receivers.

By way of example, the union of all the preferences of the users situated in the service area (or of the terminal capabilities of the corresponding client units) is clearly formed.

The refinements of the invention which are described in connection with the communication system also apply analogously to the method for controlling a broadcast communication network, the server unit, the method for operating a server unit, the client unit and the method for operating a client unit.

In one embodiment, the determination device determines that data are intended to be transmitted by means of the broadcast communication network in the service area if the number of client units for which parameter values are stored which can be used to determine that the data are intended to be communicated to the respective client unit lies above a predeterminable threshold value.

In one embodiment, the communication system furthermore has a mobile radio communication network and the determination device determines that data are intended to be transmitted by means of the mobile radio communication network if the number of client units for which parameter values are stored which can be used to determine that the data are intended to be communicated to the respective client unit lies below a predeterminable threshold value.

It may clearly be prescribed that if specific data are only intended to be communicated to very few client units, this is not carried out by means of the broadcast communication network, but rather by means of the mobile radio communication network. In this way, radio resources of the broadcast communication network can be saved if it is clearly not worth it for the broadcast communication network to communicate said data.

In one embodiment, the communication system furthermore has a mobile radio communication network by means of which client units situated in the service area can communicate further parameter values to the storage device, which can be used to determine which of the data provided are intended to be communicated to the respective client unit.

By way of example, the mobile radio communication system is configured in accordance with the UMTS (Universal Mobile Telecommunications System) standard, the GSM (Global System for Mobile Communication) standard, the GPRS (General Packet Radio Service) standard or the EDGE (Enhanced Data Rates for GSM Evolution) standard.

In one embodiment, the parameter values can be used to determine which of the data provided the user of the respective client unit would like to receive and/or which of the data provided the respective client unit can process.

In one embodiment, at least one of the client units is realized by means of a mobile radio subscriber device.

The broadcast communication network is configured, for example, in accordance with DVB-H (Digital Video Broadcast—Handheld), MBMS (Multimedia Broadcast Multicast Service) or BCMCS (Broadcast Multicast Services). The data provided are for example video data, still image data, audio data or text data. By way of example, a communication service is to be understood as a service in the context of which audio and/or video data are transmitted, for example a service for the transmission of television programs or radio programs, or a communication service for the transmission of other data, for example for downloading computer files.

The communication system is configured for example in accordance with the OMA (Open Mobile Alliance) BCAST standard.

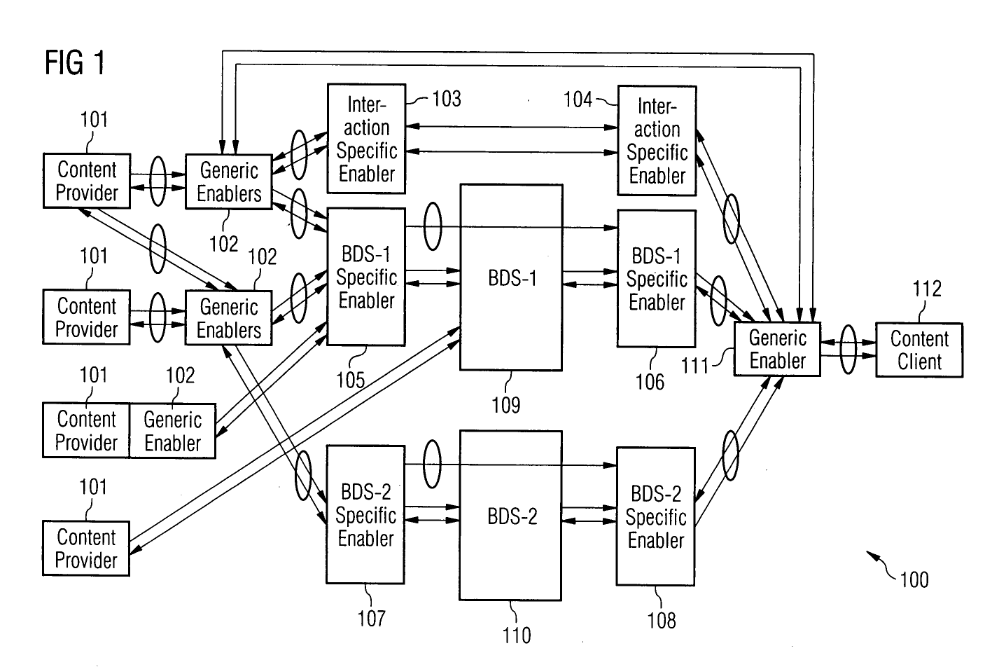

FIG. 1 shows a communication system 100 in accordance with one exemplary embodiment of the invention.

The communication system 100 is configured in accordance with the BCAST architecture.

A plurality of content providers 101 provide contents of communication services to one or more generic functions (generic enablers) 102. By way of example, in the context of a cinema film communication service, video data and audio data corresponding to a film are provided, as well as further information such as, for example, the genre of the film, the start time and end time of the provision of the video data and audio data and an indication of the contents of the film. The contents of the communication services are provided to the generic functions by means of service providers (not shown). Clearly, a content provider is an owner of the content of the communication service and a service provider provides the communication service.

The generic functions 102 provide functions specific to BCAST, for example a service guide, which in this case helps users to find contents which are of interest to the users and are provided in the context of communication services, broadcast streaming and broadcast file distribution, that is to say broadcasting of contents or data to users. For this purpose, the generic functions utilize the functionality of a first interaction specific function (interaction specific enabler) 103, a second interaction specific function 104, a first BDS specific function (BDS specific enabler) 105, a second BDS specific function 106, a third BDS specific function 107 and a fourth BDS specific function 108.

The first BDS specific function 105 forms the interface between the generic functions 102 and a first broadcast communication network 109 (BDS, broadcast distribution system), which enables the broadcast of data in at least one service area. Consequently, by means of the first BDS specific function 105, the generic functions 102 can broadcast data in the at least one service area of the first broadcast communication network 109 by means of the first broadcast communication network 109. The second BDS specific function 106 is realized by means of a user's mobile radio subscriber device and is set up to receive the data sent by means of the first broadcast communication network 109. Analogously, data which are sent from the generic functions 102 by means of the third BDS specific function 107 and by means of a second broadcast communication network 110 can be received by means of the fourth BDS specific function 108, which is realized by means of the user's mobile radio subscriber device.

The second BDS specific function 106 and the fourth BDS specific function 108 provide the received data to a further generic function 111, which is realized by means of the user's mobile radio subscriber device. The first BDS specific function 105, the second BDS specific function 106, the third BDS specific function 107 and the fourth BDS specific function 108 thus clearly serve to meet the requirements of the transmission systems used, that is to say the first broadcast communication network 109 and the second broadcast communication network 110.

The first broadcast communication network 109 and the second broadcast communication network 110 are realized for example in accordance with DVB-H (digital video broadcast—handheld), MBMS (multimedia broadcast multicast service) or BCMCS (broadcast multicast services).

Furthermore, data can be communicated from the generic functions 102 to the further generic function 111 and also from the further generic function 111 to the generic functions 102 by means of the first interaction specific function 103 and the second interaction specific function 104. The first interaction specific function 103 and the second interaction specific function 104 form the interface between the generic function 102 and, respectively, the further generic function 111 and a bidirectional communication network and meet the specific requirements thereof. The bidirectional communication network which enables the bidirectional communication by means of the first interaction specific function 103 and the second interaction specific function 104 is for example a mobile radio communication network in accordance with the UMTS (universal mobile telecommunication system) standard, the GSM (global system for mobile communications) standard, the GPRS general packet radio system) standard or the EDGE (enhanced data rates for GSM evolution) standard.

The data which are received by the further generic function 111 in the context of a communication service provided by the content providers are provided to a content client 112, which is likewise realized by means of the corresponding mobile radio subscriber device. The content client 112 presents the data to the user in a suitable form, for example plays back a video clip corresponding to received video data by means of the display of the mobile radio subscriber device. By means of the content client 112, the user can furthermore perform settings with regard to the reception of data. These are forwarded if appropriate, if it is required, by means of the second interaction specific function 104 and the first interaction specific function 103 to the network, that is to say to the generic functions 102 and to the content providers 101.

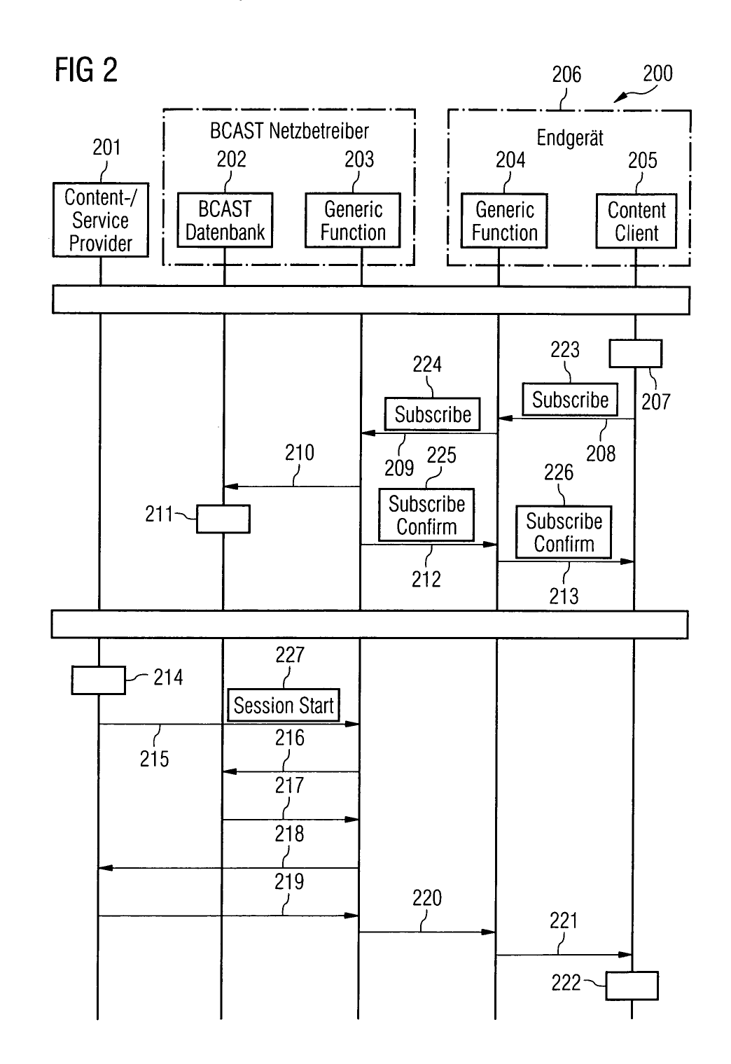

FIG. 2 shows a flow chart 200 in accordance with one exemplary embodiment of the invention.

The sequence illustrated involves the participation of a content provider (with corresponding service provider) 201, which is configured as explained with reference to FIG. 1, a BCAST database 202, the functionality of which is explained below, a first generic function 203, which is arranged and configured according to the generic functions 102 shown in FIG. 1, a second generic function 204 and a content client 205. The second generic function 204 and the content client 205 correspond to the further generic function 111 and the content client 112 in FIG. 1 and are realized in particular by means of a mobile radio subscriber device 206. The content provider 201 provides data in the context of a communication service, which data can be sent by means of the first generic function 203 and a broadcast communication network and, as explained with reference to FIG. 1, can be received by the mobile radio subscriber device 206 by means of the second generic function 204 and can be presented by the content client 205 or, for example in the case of audio data, be played back.

It is correspondingly assumed that the user of the mobile radio subscriber device 206 is situated together with his mobile radio subscriber device 206 in a service area of the broadcast communication network which is used for sending the data. It is furthermore assumed that further users equipped with mobile radio subscriber devices analogously to the user are situated in the service area. It is furthermore assumed that data can be sent in the service area independently of other service areas of the broadcast communication network. That is to say that by means of the broadcast communication network data which are not sent in other service areas can be sent in the service area or data which are not sent in the service area can be sent in other service areas by means of the broadcast communication network.

It is assumed that the communication service provided by the content provider 201 is a cinema film communication service in the context of which video data, music data, speech data (speech audio data), subtitle data and supplementary information for cinema films are provided.

The user's mobile radio subscriber device 206 furthermore realizes, as explained with reference to FIG. 1, an interaction specific function by means of which data can be communicated from the mobile radio subscriber device 206 to the first generic function 203 by means of a corresponding interaction specific function (at the network end).

In step 207, the user of the mobile radio subscriber device 206 informs the content client 205 by means of a corresponding user input that the user would like to register for the (cinema film) communication service. Furthermore, the user performs settings with regard to the use of the communication service. In particular, the user specifies personal preferences, which in this example shall be

video=yes (that is to say the user would like to receive video data)

music=yes (that is to say the user would like to receive music data)

language=German (that is to say the user would like to receive speech data for the German language)

subtitles=no (that is to say the user would not like any subtitles)

additional info=no (that is to say no additional information is to be sent to the user)

These personal preferences of the user are referred to hereinafter as the subscriber preferences of the user.

In step 208, the content client 205 transmits to the second generic function 204 a first subscription message (subscribe message) 223, which contains an identification of the communication service and the subscriber preferences of the user.

In step 209, the second generic function 204 transmits to the first generic function 203 a second subscription message (subscribe message) 224, which contains (at least) an identification of the user, an identification of the communication service, the subscriber preferences and the terminal capabilities. The terminal capabilities are parameter values specifying what data can be received and processed (maximally) by the mobile radio subscriber device. The parameter values specify for example the resolution of the display of the mobile radio subscriber device, the maximum data rate supported by the mobile radio subscriber device for the reception of data, etc.

In step 210, the first generic function 203 recognizes that the second subscription message 224 involves a desired subscription for a new communication service. The first generic function 203 correspondingly updates the BCAST database 202.

The BCAST database 202 has the following structure:

The following are stored for each BCAST service (that is to say for each communication service for which the BCAST database is used):
an identification of the BCAST service;
   an identification of the service area for which the BCAST database 202 is set up (in this case of the service area in which the mobile radio subscriber device 206 is situated);
   the number of users situated in the service area;
   and for each user situated in the service area:
      an identification of the user;
      the subscriber preferences;
      the terminal capabilities.

Correspondingly, an entry in the BCAST database 202 is performed in step 211, so that, for the communication service whose identification is stored in the BCAST database 202, an entry for the user exists which contains an identification of the user, the subscriber preferences of the user and the terminal capabilities of the mobile radio subscriber device 206.

The BCAST database 202 may be configured as a separate database or be integrated into an existing database, for example into a UA-prof (user agent profile) database, an HLR (home location register) or an HSS (home subscriber server), which are present according to the mobile radio communication network used for the bidrectional data transmission.

In step 212, the first generic function 203 communicates by means of a dedicated communication link, for example by means of a UMTS communication network and corresponding interaction specific functions, a first confirmation message (subscribe confirm message) 225 to the second generic function 204, by means of which the fact that the desired subscription was successful is signaled. The confirmation message 225 contains at least the identification of the user that is used and the identification of the communication service that is used.

In step 213, the second generic function 204 communicates a second confirmation message (subscribe confirm message) 226 to the content client 205, by means of which the fact that the desired subscription was successful is signaled. The second confirmation message 226 contains at least the identification of the user (subscriber ID) that is used and the identification of the communication service (service ID) that is used.

The user is now registered for the cinema film communication service. It is assumed that data are transmitted in the context of the communication service hereinafter. In step 214, the content provider 201 (or the associated service provider) plans the transmission of data within the context of the communication service; by way of example there is precisely a specific time of day at which a cinema film is intended to be communicated to the users who have registered for the communication service.

In step 215, the content provider 201 (or the associated service provider) communicates a start signaling message (session start message) 227 to the first generic function 203. The start signaling message 227 contains at least the identification of the communication service that is used.

In step 216, the first generic function 203 thereupon interrogates the entries stored in the BCAST database 202 with respect to the communication service. Inter alia, this involves interrogating how many users situated with their respective mobile radio subscriber device in the service area have registered for the communication service and what subscriber preferences are stored for said users. The users who have registered for the communication service and are situated with their respective mobile radio subscriber device in the service area are referred to hereinafter as subscribers (of the communication service). It is assumed that a high number of subscribers exists, that is to say that in particular a high number of users have registered for the communication service. It is therefore decided that the data to be sent in the context of the communication service are intended to be sent by means of the broadcast communication network. It is furthermore assumed that no subscriber preferences of the users conflict with the “overall” preferences

video=yes

music=yes

language=German, English

subtitles=no

additional info=yes

that is to say that none of the subscribers would like to receive speech data for languages other than German or English, and that no subscribers would like to receive subtitles.

Conversely, it is assumed that the subscriber preferences of at least one subscriber specify that the subscriber would like to receive video data (which is given by the user of the mobile radio subscriber device 206), that the subscriber preferences of at least one subscriber specify that the subscriber would like to receive audio data (which is likewise given by the user of the mobile radio subscriber device 206), that the subscriber preferences of at least one subscriber specify that the subscriber would like to receive audio data for the German language (which is likewise given by the user of the mobile radio subscriber device 206), that the subscriber preferences of at least one subscriber specify that the subscriber would like to receive audio data for the English language, and that the subscriber preferences of at least one subscriber specify that the subscriber would like to receive additional information.

Clearly, the overall preferences indicated above form the smallest superset of the subscriber preferences of all the subscribers.

In step 217, the BCAST database 202 correspondingly replies to the inquiry of the first generic function 203.

In step 218, the first generic function 203 interrogates from the content provider 201 (or from the associated service provider) only the media streams, that is to say the components of the communication service, which, as can be recognized from the subscriber preferences, are required. If it can be recognized from the subscriber preferences that none of the subscribers would like to receive a specific component, then the latter is not interrogated either. In the present example, for example only the speech data for the German language and the English language are interrogated, but not for example for the French language. In the concrete example, the first generic function 203 thus interrogates video data, music data, speech data for the German and English languages and the additional information (corresponding to the overall preferences indicated above).

In the context of the interrogation, the first generic function 203 signals the identification of the communication service that is used, and specifies the media streams (service components) which are requested. In one embodiment, the terminal capabilities are also taken into account in the interrogation. If, for example, none of the mobile radio subscriber devices used by the subscribers is capable of processing and displaying the video data with a high resolution, then the video data are correspondingly only requested in a low resolution.

Clearly, the first generic function 203 generates the data to be transmitted only from the media streams which are actually desired to be received by at least one user in the service area (corresponding to the subscriber preferences specified by the subscribers) and can be received and processed (corresponding to the terminal capabilities of the mobile radio subscriber devices used by the subscribers). The first generic function 203 thus interrogates media streams from the content provider 201 (or the corresponding associated service provider) which were also actually intended to be transmitted.

In step 219, the content provider 201 (or the associated service provider) replies to the inquiry of the first generic function 203 and communicates the media streams requested, in this example video data, music data, speech data for the German language and the English language and the additional information.

In step 220, the first generic function 203 transmits the requested media streams, which, as explained, are also the media streams to be transmitted, by means of the broadcast communication network. The second generic function 204 receives the media streams sent. The media streams are sent in synchronized fashion, that is to say that, for example, video data and audio data which correspond to one and the same scene of the cinema film are sent simultaneously.

In step 221, the second generic function 204 filters from the media streams sent only the media streams which are desired by the user (and, in one embodiment, correspond to the capabilities of the mobile radio subscriber device 206) and forwards them to the content client 205. In particular, in this example, the speech data for the English language and the additional information are not forwarded to the content client 205. In step 222, the content client 205 presents the media streams in a suitable manner, for example plays back the cinema film comprising video, music and German language.

In one embodiment, the first generic function 203 is furthermore set up to communicate by means of the first interaction specific function 103 and by means of the second interaction specific function 104, that is to say for example by means of a UMTS mobile radio network, to the mobile radio subscriber device 206 items of synchronization information, that is to say items of information which enable the mobile radio subscriber device 206 to synchronize the transmitted media streams.

In the above example, it was assumed, as mentioned above, that the number of subscribers is large (cf. step 216), and that for this reason it is decided that the media streams to be transmitted are communicated by means of the broadcast communication network. In one embodiment, if the number of subscribers lies below a predeterminable threshold value, the media streams to be transmitted are not communicated by means of the broadcast communication network, but rather by means of the first interaction specific function 103 and by means of the second interaction specific function 104, for example by means of a mobile radio network using dedicated channels. This can also be done separately for selected media streams. If, by way of example, a large number of subscribers would like to receive video data but only a small number of subscribers would like to receive speech data for the English language, then the video data are transmitted by means of the broadcast communication network and the speech data for the English language are transmitted by means of the mobile radio network by means of dedicated channels.

Further radio resources can be saved by the utilization of dedicated channels for the transmission of media streams which are only desired by few subscribers. The decision regarding which media streams are communicated by means of the mobile radio communication network and which media streams are communicated by means of the broadcast communication network is taken by the first generic function 203 in this embodiment.

If, in the context of a communication service, some media streams are communicated by means of the mobile radio communication network and some media streams are communicated by means of the broadcast communication network, then the media streams that are transmitted (clearly separately) by means of the mobile radio communication network are communicated, in one embodiment, with a suitable small temporal offset, so that the media streams can be received synchronously (or with a small temporal offset) and thus be assembled correctly in the mobile radio subscriber device 206.

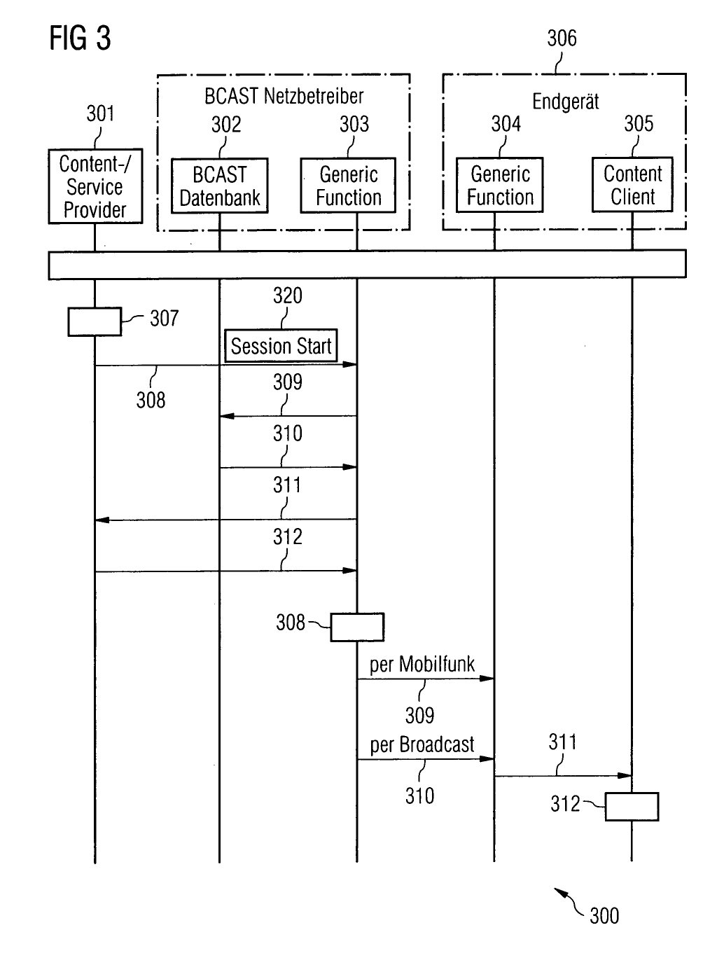

A sequence in accordance with an exemplary embodiment in which a portion of the media streams of a communication service that is provided are communicated by means of a mobile radio communication network is explained below with reference to FIG. 3.

FIG. 3 shows a flow chart 300 in accordance with one exemplary embodiment of the invention.

Analogously to the sequence illustrated in FIG. 2, the sequence illustrated in FIG. 3 involves the participation of a content provider (with a corresponding service provider) 301, a BCAST database 302, a first generic function 303, a second generic function 304 and a content client 305, which are configured as explained with reference to FIG. 2 and FIG. 1. The second generic function 304 and the content client 305 are realized by means of a mobile radio subscriber device 306. Analogously to above, the content provider 301 provides data in the context of a communication service.

Analogously to the exemplary embodiment explained with reference to FIG. 2, a broadcast communication network enables the data transmission from the first generic function 303 to the second generic function 304 in a service area of the broadcast communication network. Furthermore, analogously to the exemplary embodiment explained with reference to FIG. 2, a mobile radio communication network enables the (bidrectional) data transmission between the first generic function 303 and the second generic function 304.

Analogously to step 214, the content provider 301 (or the associated service provider) plans, in step 307, the transmission of data in the context of the communication service that is provided.

It is assumed that steps analogous to steps 207 to 213 have been carried out prior to step 307, so that in particular the BCAST database 302 is set up as explained above, that is to say that the subscriber preferences of the users situated in the service area and the terminal capabilities of the client units used by the users are stored in the BCAST database 302 as explained above.

In step 308, the content provider 301 (or the associated service provider) communicates, analogously to step 215, a start signaling message (session start message) 320 to the first generic function 303.

Steps 309 to 312 are carried out analogously to steps 216 to 219.

In step 308, the generic function 308 determines, using the subscriber preferences and the terminal capabilities, for each media stream, the number of client units to which the respective media stream is to be transmitted.

If it is determined for a media stream that the number of client units to which the media stream is to be transmitted lies below a limit value that is predetermined (for example by the operator of the broadcast communication network), then in step 309 the media stream is communicated to the second generic function 304 by means of the mobile radio communication network.

If it is determined for a media stream that the number of client units to which the media stream is to be transmitted lies above a limit value that is predetermined (for example by the operator of the broadcast communication network), then in step 310 the media stream is communicated to the second generic function 304 by means of the broadcast communication network.

The transmission of media streams by means of the mobile communication network is carried out with a temporal offset in one embodiment as explained above.

Analogously to step 221, the second generic function 304 filters the media streams received by means of the mobile radio communication network or the broadcast communication network and forwards them to the content client 305, which presents them or plays them back in step 312 analogously to step 222.

While the invention has been shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes that come within the meaning and range of equivalency of the claims are intended to be embraced.

What is claimed is:

1. A server unit of a communication system having a broadcast communication network, a communication service server unit and a storage device, the server unit providing, in context of a communication service, a plurality of media streams which can be transmitted in at least one service area of the broadcast communication network by the broadcast communication network, the server unit comprising:
a determination device that interrogates parameter values from a storage device for each client unit which is situated in the service area, and receives data which are transmitted by the broadcast communication network, wherein the parameter values are used to determine which of the media streams are intended to be communicated to the respective client unit; and determines, based on the parameter values, which of the media streams are intended to be transmitted by the broadcast communication network in the service area; and
a controller device that controls the broadcast communication network such that the broadcast communication network transmits the media streams which are intended to be transmitted.

2. The server unit as claimed in claim 1, wherein the determination device determines that data are intended to be transmitted by the broadcast communication network in the service area if the number of client units for which parameter values are stored lies above a predetermined threshold value.

3. The server unit as claimed in claim 1, wherein the determination device determines that data are intended to be transmitted by a mobile radio communication network if the number of client units for which parameter values are stored lies below a predetermined threshold value.

4. The server unit as claimed in claim 1, further comprising:
a receiver that receives further parameter values, which are used to determine which of the data are intended to be communicated to a respective client unit.

5. The server unit as claimed in claim 1, wherein the server unit is a UMTS server unit, a GSM server unit, a GPRS server unit, or an EDGE server unit.

6. The server unit as claimed in claim 1, wherein the parameter values are used to determine which of the data the user of a respective client unit would like to receive and/or which of the data a respective client unit can process.

7. The server unit as claimed in claim 1, wherein the data is video data, still image data, audio data, or text data.

8. A method for operating a server unit of a communication system having a broadcast communication network, a communication service server unit and a storage device, comprising the steps of:
providing, in context of a communication service, a plurality of media streams which are transmitted in at least one service area of the broadcast communication network by the broadcast communication network;
interrogating parameter values for each client unit which is situated in the service area and receiving data which are transmitted by the broadcast communication network, which parameter values are used to determine which of the media streams are intended to be communicated to the respective client unit, and determining, based on the parameter values, which of the media streams are intended to be transmitted by the broadcast communication network in the service area; and
controlling the broadcast communication network such that the broadcast communication network transmits the media streams which are intended to be transmitted.

9. A communication system comprising:
a broadcast communication network;
a communication service server unit providing, in context of a communication service, a plurality of media streams which are transmitted in at least one service area of the broadcast communication network by means of the broadcast communication network;
a storage device that stores parameter values for each client unit which is situated in the service area, and is set up to receive data transmitted by the broadcast communication network, wherein the parameter values are used to determine which of the media streams are intended to be communicated to the respective client unit;
a determination device that determines based on the parameter values which of the media streams are intended to be transmitted by means of the broadcast communication network in the service area; and
a controller device that controls the broadcast communication network such that the broadcast communication network transmits the media streams which are intended to be transmitted.

10. The communication system as claimed in claim 9, wherein the determination device determines that data are intended to be transmitted by means of the broadcast communication network in the service area if the number of client units for which parameter values are stored lies above a predetermined threshold value.

11. The communication system as claimed in claim 9, further comprising a mobile radio communication network,
wherein the determination device determines that data are intended to be transmitted by means of the mobile radio communication network if the number of client units for which parameter values are stored lies below a predetermined threshold value.

12. The communication system as claimed in claim 9, further comprising a mobile radio communication network by means of which client units situated in the service area communicate to the storage device further parameter values, which are used to determine which of the data are intended to be communicated to the respective client unit.

13. The communication system as claimed in claim 11, wherein the mobile radio communication network is a UMTS communication system, a GSM communication system, a GPRS communication system, or an EDGE communication system.

14. The communication system as claimed in claim 9, wherein the parameter values are used to determine which of the data the user of the respective client unit would like to receive.

15. The communication system as claimed in claim 9, wherein the parameter values are used to determine which of the data the respective client unit can process.

16. The communication system as claimed in claim 9, wherein at least one of the client units is a mobile radio subscriber device.

17. The communication system as claimed in claim 9, wherein the broadcast communication network is a DVB-H broadcast communication network, an MBMS broadcast communication network, or a BCMCS broadcast communication network.

18. The communication system as claimed in claim 9, wherein the data is video data, still image data, audio data, or text data.

19. The communication system as claimed in claim 9, wherein the communication system is an OMA BCAST communication system.

20. A method of controlling a broadcast communication network of a communication system having a communication service server unit, a determination device and a controller device, the method comprising the steps of:
providing, in context of a communication service, a plurality of media streams which can be transmitted in at least one service area of the broadcast communication network by means of the broadcast communication network;
storing parameter values for each client unit which is situated in the service area, and is receiving data which are transmitted by means of the broadcast communication network, wherein the parameter values can be used to determine which of the media streams are intended to be communicated to the respective client unit,
wherein the determination device determines based on the parameter values, which of the media streams are intended to be transmitted by means of the broadcast communication network in the service area; and
controlling the broadcast communication network such that the broadcast communication network transmits the media streams which are intended to be transmitted.

21. A client unit of a communication system, comprising a signaling device communicating to a server unit a message with parameter values which are used to determine which of a plurality of media streams provided by a communication service server unit in context of a communication service are intended to be communicated to the client unit by means of a broadcast communication network of the communication system.

22. A method for operating a client unit of a communication system, comprising the steps of communicating to a server unit a message with parameter values which are used to determine which of a plurality of media streams provided by a communication service server unit in context of a communication service are intended to be communicated to the client unit by means of a broadcast communication network of the communication system.

23. A server unit of a communication system having a broadcast communication network, a communication service server unit and a storage device, the server unit providing, in context of a communication service, a plurality of media streams which can be transmitted in at least one service area of the broadcast communication network by the broadcast communication network, the server unit comprising:
a determination means that interrogates parameter values from a storage means for each client unit which is situated in the service area, and receives data which are transmitted by the broadcast communication network, wherein the parameter values are used to determine which of the media streams are intended to be communicated to the respective client unit; and determines, based on the parameter values, which of the media streams are intended to be transmitted by the broadcast communication network in the service area; and
a controller means that controls the broadcast communication network such that the broadcast communication network transmits the media streams which are intended to be transmitted.
